(19) United States
(12) Patent Application Publication
(10) Pub. No.: US 2023/0364996 A1
(43) Pub. Date: Nov. 16, 2023

(54) POWER INVERTER MONITORING AND PROGNOSIS FOR VEHICLES

(71) Applicant: GM Global Technology Operations LLC, Detroit, MI (US)

(72) Inventors: Jiyu Zhang, Sterling Heights, MI (US); Bojian Cao, Troy, MI (US); Nomar S. Gonzalez Santini, Lakeland, FL (US); Jeffrey Scott Piasecki, Rochester, MI (US); Tanvi Nagarale, Auburn Hills, MI (US); Muhammad Hussain Alvi, Troy, MI (US); Rashmi Prasad, Troy, MI (US)

(21) Appl. No.: 17/740,955

(22) Filed: May 10, 2022

(51) Int. Cl. B60L 3/00

(52) U.S. Cl. CPC B60L 3/003; B60L 2240/525; B60L 2240/527

(57) ABSTRACT

Examples described herein provide a method that includes performing an electrical degradation analysis for a power inverter. The method further includes performing a thermal degradation analysis on the power inverter. The method further includes, responsive to at least one of a result of the electrical degradation analysis being indicative of an electrical issue of the power inverter or a result of the thermal degradation analysis being indicative of a thermal issue of the power inverter, implementing a corrective action for the power inverter.

### INTRODUCTION

The subject disclosure relates to vehicles and more particularly to power inverter monitoring and prognosis for vehicles.

Electric vehicles, including hybrid electric vehicles, include at least one rotary traction motor for producing propulsion power. Brushless AC motors are a popular choice for propulsion motors. AC motors include a stator including one or more phases of AC power. Typically, AC propulsion motors are polyphase and employ three or more phases of AC power to generate a rotating magnetic field in the stator to drive the motor’s rotor.

Electric and hybrid vehicles may include a high voltage (HV) energy storage device (ESD) for providing power to drive the propulsion motor(s) and to low voltage (LV) applications. ESDs are typically electrochemical devices. Inverters are employed to convert the DC power of the ESD to AC power to drive the propulsion motor(s) by way of a rotating magnetic field. Inverters may be bidirectional and operated to convert AC power from the propulsion motor operating in a regenerating mode to DC power which is returned to the ESD. Similarly, the inverter may be employed in ESD bulk recharging.

### SUMMARY

In one exemplary embodiment, a method is provided. The method includes performing an electrical degradation analysis for a power inverter. The method further includes performing a thermal degradation analysis on the power inverter. The method further includes, responsive to at least one of a result of the electrical degradation analysis being indicative of an electrical issue of the power inverter or a result of the thermal degradation analysis being indicative of a thermal issue of the power inverter, implementing a corrective action for the power inverter.

In addition to one or more of the features described herein, or as an alternative, further embodiments of the method may include that the electrical degradation analysis includes measuring a measured collector-to-emitter voltage (V_{ce}) for the power inverter. The electrical degradation analysis further includes calculating a voltage difference between the measured collector-to-emitter voltage (V_{ce}) and an expected collector-to-emitter voltage (V_{ce}). The electrical degradation analysis further includes determining whether the voltage difference satisfies a voltage threshold.

In addition to one or more of the features described herein, or as an alternative, further embodiments of the method may include that the electrical degradation analysis further includes, responsive to determining that the voltage difference satisfies the voltage threshold, determining that an electrical degradation of the power inverter has occurred.

In addition to one or more of the features described herein, or as an alternative, further embodiments of the method may include that the electrical degradation analysis further includes, responsive to determining that the voltage difference failing to satisfy the voltage threshold, restarting the electrical degradation analysis.

In addition to one or more of the features described herein, or as an alternative, further embodiments of the method may include that the thermal degradation analysis further includes calculating an inverter damage factor and determining whether the inverter damage factor satisfies a first thermal threshold.

In addition to one or more of the features described herein, or as an alternative, further embodiments of the method may include that the thermal degradation analysis further includes calculating a thermal resistance and determining whether the thermal resistance satisfies a second thermal threshold.

In addition to one or more of the features described herein, or as an alternative, further embodiments of the method may include that the thermal degradation analysis further includes, responsive to determining that the inverter damage factor satisfies the first thermal threshold and responsive to determining that the thermal resistance satisfies the second thermal threshold, determining that an thermal degradation of the power inverter has occurred.

In addition to one or more of the features described herein, or as an alternative, further embodiments of the method may include that the thermal degradation analysis further includes, responsive to determining that the inverter damage factor fails to satisfy the first thermal threshold or responsive to determining that the thermal resistance fails to satisfy the second thermal threshold, restarting the thermal degradation analysis.

In addition to one or more of the features described herein, or as an alternative, further embodiments of the method may include that the inverter damage factor is calculated using a rainflow counting technique.

In addition to one or more of the features described herein, or as an alternative, further embodiments of the method may include, prior to performing an electrical degradation analysis and prior to performing a thermal degradation analysis estimating an inverter power loss, estimating an inverter junction temperature, calculating an inverter damage factor, and feeding back inverter degradation information to the estimations.

In another exemplary embodiment a system includes a memory comprising computer readable instructions and a processing device for executing the computer readable instructions. The computer readable instructions control the processing device to perform operations. The operations include performing an electrical degradation analysis for a power inverter. The operations further include performing a thermal degradation analysis on the power inverter. The operations further include responsive to at least one of a result of the electrical degradation analysis being indicative of an electrical issue of the power inverter or a result of the thermal degradation analysis being indicative of a thermal issue of the power inverter, implementing a corrective action for the power inverter.

In addition to one or more of the features described herein, or as an alternative, further embodiments of the system may include that the electrical degradation analysis includes measuring a measured collector-to-emitter voltage (V_{ce}) for the power inverter. The electrical degradation analysis further includes calculating a voltage difference between the measured collector-to-emitter voltage (V_{ce}) and an expected collector-to-emitter voltage (V_{ce}). The electrical degradation analysis further includes determining whether the voltage difference satisfies a voltage threshold.

In addition to one or more of the features described herein, or as an alternative, further embodiments of the system may include that the electrical degradation analysis further includes, responsive to determining that the voltage difference satisfies the voltage threshold, determining that an electrical degradation of the power inverter has occurred.

In addition to one or more of the features described herein, or as an alternative, further embodiments of the system may include that the electrical degradation analysis further includes, responsive to determining that the voltage difference failing to satisfy the voltage threshold, restarting the electrical degradation analysis.

In addition to one or more of the features described herein, or as an alternative, further embodiments of the system may include that the thermal degradation analysis further includes calculating an inverter damage factor and determining whether the inverter damage factor satisfies a first thermal threshold.

In addition to one or more of the features described herein, or as an alternative, further embodiments of the system may include that the thermal degradation analysis further includes calculating a thermal resistance and determining whether the thermal resistance satisfies a second thermal threshold.

In addition to one or more of the features described herein, or as an alternative, further embodiments of the system may include that the thermal degradation analysis further includes, responsive to determining that the inverter damage factor satisfies the first thermal threshold and responsive to determining that the thermal resistance satisfies the second thermal threshold, determining that an thermal degradation of the power inverter has occurred.

In addition to one or more of the features described herein, or as an alternative, further embodiments of the system may include that the thermal degradation analysis further includes, responsive to determining that the inverter damage factor fails to satisfy the first thermal threshold or responsive to determining that the thermal resistance fails to satisfy the second thermal threshold, restarting the thermal degradation analysis.

In addition to one or more of the features described herein, or as an alternative, further embodiments of the system may include that the voltage threshold is determined based at least in part on the measured collector-to-emitter voltage (V_{ce}) or a drain-to-source voltage (V_{ds}) value at a start of life and is updated over time.

In addition to one or more of the features described herein, or as an alternative, further embodiments of the system may include that a difference between the V_{ce} of two or more switches of the power inverter indicates a start of an ageing related issue.

The above features and advantages, and other features and advantages of the disclosure are readily apparent from the following detailed description when taken in connection with the accompanying drawings.

### BRIEF DES CRIPTION OF THE DRAWINGS

Other features, advantages, and details appear, by way of example only, in the following detailed description, the detailed description referring to the drawings in which:

FIG. 1 illustrates an exemplary propulsion system of a vehicle according to one or more embodiments described herein;

FIG. 2 depicts the controller of FIG. 1 having monitoring capabilities according to one or more embodiments described herein;

FIG. 3 depicts a flow diagram of a method for analyzing power inventers for vehicles according to one or more embodiments described herein; and

FIG. 4A depicts a flow diagram of a method for performing an electrical degradation analysis and a thermal degradation analysis for power inventers for vehicles according to one or more embodiments described herein;

FIG. 4B depicts a flow diagram of a method for performing a thermal degradation analysis and a thermal degradation analysis for power inverters for vehicles according to one or more embodiments described herein; and

FIG. 5 depicts a block diagram of a processing system for implementing the techniques described herein according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein provide for power inverter monitoring and prognosis for vehicles. More particularly, one or more embodiments described herein provides for dynamically monitoring power inverter aging based on inverter electrical and thermal degradation. One or more embodiments described herein also provides a framework for power inverter life prognostics.

Conventional power inverter modules do not have aging and life monitoring or prognosis capabilities. One or more embodiments described herein address these and other shortcomings by providing power inverter module aging estimation that takes into consideration thermal degradation and electrical degradation. As one example, a method according to one or more embodiments can include performing an electrical degradation analysis for a power inverter of a vehicle and performing a thermal degradation analysis on the power inverter of the vehicle. The example method further includes, responsive to at least one of a result of the electrical degradation analysis being indicative of an electrical issue of the power inverter or a result of the thermal degradation analysis being indicative of a thermal issue of the power inverter, implementing a corrective action for the power inverter. This approach provides for early detection of inverter degradation (electrical and thermal) by implementing thresholds that capture the fault (electrical degradation and/or thermal degradation) at an early stage. An alert can then be issued before a power inverter failure occurs, which can prevent sudden loss of propulsion and walk home situations.

One or more embodiments described herein provide advantages and improvements over the prior art. For example, the described technical solutions detect inverter electrical and/or thermal degradation events and provide for corrective action(s) to be taken before failure of the inverter. Further, one or more embodiments described herein provide for power inverter state of health analysis for prognosis and preventive maintenance.

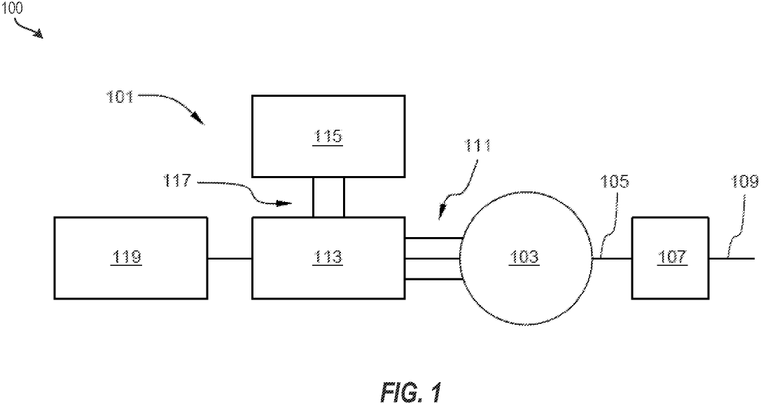

FIG. 1 illustrates an exemplary propulsion system 101 of a vehicle 100 according to one or more embodiments described herein. Propulsion system 101 may include an electric drive unit (EDU) of varying complexity, componentry and integration. An exemplary highly integrated EDU may include, for example, an electric motor, reduction and differential gearing, housings including air and liquid cooling features, electrical bus structures, HV bus structures, power electronics (e.g., inverters), controllers, and other related components. Propulsion system 101 may include AC electric machine (hereafter AC motor) 103 having a motor output shaft 105. The motor output shaft 105 may transfer torque between the AC motor 103 and other driveline components, for example a final drive 107 which may include reduction and differential gear sets and one or more axle outputs. Final drive 107 may simply include reduction gearing and a prop shaft output coupling to a differential gear set. One or more axles 109 may couple to the final drive 107 or differential gear sets if separate therefrom. Axle(s) 109 may couple to a vehicle wheel(s) for transferring tractive force between a wheel and pavement. One having ordinary skill in the art will recognize alternative arrangements for driveline components including motor-at-wheel arrangements or final drive gearsets including additional power take offs in addition to axle or prop shaft take offs. Regardless of the application arrangement, the driveline components are effective to transfer motor torque between one or more wheels and pavement.

AC motor 103 may be a polyphase AC motor such as a three phase AC motor receiving three-phase AC power over AC bus 111 which is coupled to inverter 113 (i.e., a power inverter). Inverter 113 may include one or more solid-state switches such as an insulated-gate bipolar transistor (IGBT) and/or a power metal-oxide-semiconductor field-effect transistor (MOSFET). The inverter 113 receives direct current (DC) power over high voltage (HV) DC bus 117 from energy storage device (ESD) 115, for example at 400 volts. Controller 119 is coupled to inverter for control thereof.

Control of inverter 113 may include high frequency switching of solid-state switching devices. A number of design and application considerations and limitations determine inverter switching frequency. Commonly, inverter controls for AC motor applications may include fixed switching frequencies, for example switching frequencies around 10-12 kHz, but other switching frequencies are also possible.

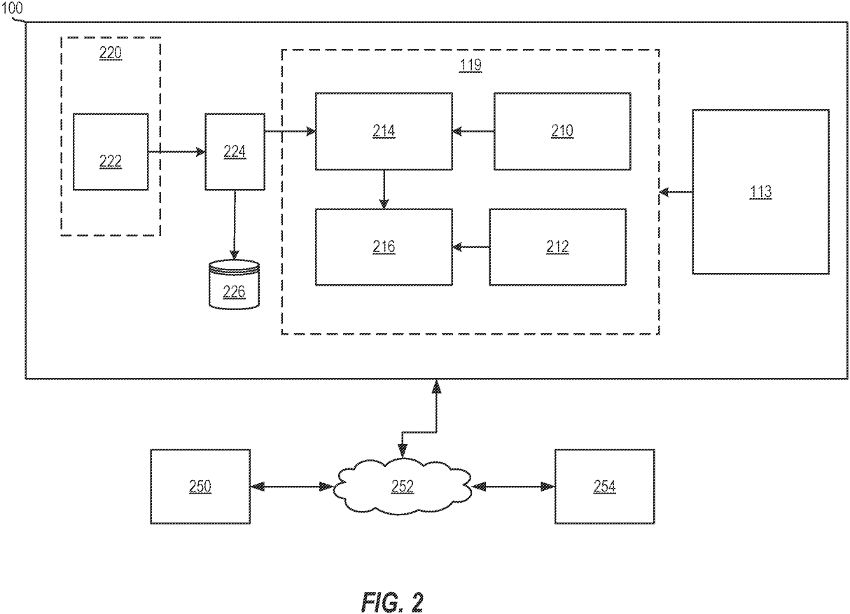

The controller 119, also referred to as an electric drive electronic control unit (ECU) can also provide monitoring capabilities for monitoring the inverter 113. For example, FIG. 2 depicts the controller 119 of FIG. 1 having monitoring capabilities according to one or more embodiments described herein. Monitoring capabilities can include, for example, power inverter (e.g., the inverter 113) module aging estimation that takes into consideration thermal degradation and electrical degradation. That is, the controller 119 can perform an electrical degradation analysis and/or a thermal degradation analysis.

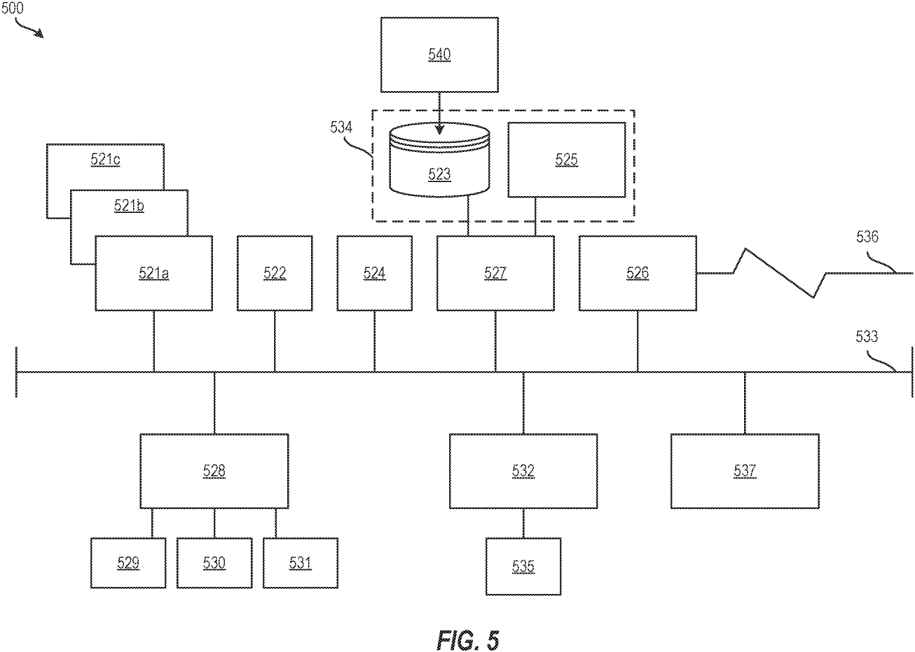

In the example of FIG. 2, the controller 119 includes an electrical degradation engine 210 and a thermal degradation engine 212, each of which monitor conditions from the inverter 113. Although not shown, the controller 119 can include other components, engines, modules, etc., such as a processor (e.g., a central processing unit, a graphics processing unit, a microprocessor, the CPU 521 of FIG. 5, etc.), a memory (e.g., a random-access memory, a read-only memory, the RAM 524 of FIG. 5, the ROM 522 of FIG. 5, etc.), data store (e.g., a solid state drive, a hard disk drive, the hard disk, the mass storage 534 of FIG. 5, etc.) and the like.

The engines 210, 212 detect inverter switching device (IGBT or MOSFET and diode) electrical and thermal degradation and life aging respectively. To determine such degradation (electrical and thermal), the controller 119 calculates health indicators for electrical and thermal degradation based on the available on-board signals, such as signals received from the inverter 113 and/or other data, such as data collected by sensor(s) associated with the vehicle 100. For example, vehicle systems 220, which could be any control, power, and/or other system, including combinations thereof, can generate data that can be used by the controller 119 to determine electrical and/or thermal degradation. As an example, one or more sensors 222 collect data 224 about one or more aspects of one or more vehicle systems 220. Examples of such data can include one or more of a power factor angle (Φ), a modulation index (MI), a switching frequency (f_{sw}), a measured three-phase current (I_{abc}), a fundamental frequency (f_{fund}), and/or the like, including combinations and/or multiples thereof. The data can be passed to the controller 119, stored in a datastore 226, and/or transmitted to another device/system, such as a remote processing system 250, other vehicle(s) 254, and/or the like.

To determine electrical degradation, the electrical degradation engine 210 uses IGBT collector-to-emitter voltage (V_{ce}) or MOSFET drain-to-source voltage (V_{ds}). The collector-to-emitter voltage (V_{ce}) (or on stage voltage drop) is an electrical parameter that is used to identify a wire bond failure mechanism. With the evolution of the wire bond fatigue, there is an increase in the effective IGBT on-state resistance, which subsequently increases the voltage V_{ce} of IGBT devices. It is known that a number of cycles to failure for the device changes in junction temperature. Thus, an increase in a change in junction temperature increases the voltage V_{ce} and decreases the device’s lifetime.

The voltages V_{ce} and/or V_{ds} can be measured, for example, online using an optocoupler-based V sensing or estimated, for example, using a lookup table based on V_{ce}/V_{ds} characteristics with respect to inverter current and temperature. The electrical degradation engine 210 can also or instead use an on-state resistance of semiconductor devices to indicate electrical degradation. According to one or more embodiments described herein, one or more switches in the inverter 113 (e.g., each of six switches) could be monitored for V_{ce}, and the thresholds described herein may or may not be same for each switch. In such an embodiment, a difference between the V_{ce} of the two or more switches can also indicate the start of an ageing related issue.

As an example, the electrical degradation engine 210 determines the electrical degradation using the following equation:

$${R}_{o n} = \frac{{V}_{c e} \left({V}_{d s}\right)}{{I}_{s}}$$

where Rₒₙ is the on-resistance, V_{ce} is collector-to-emitter voltage, V_{ds} is the source drain voltage, and Iₛ is the source current.

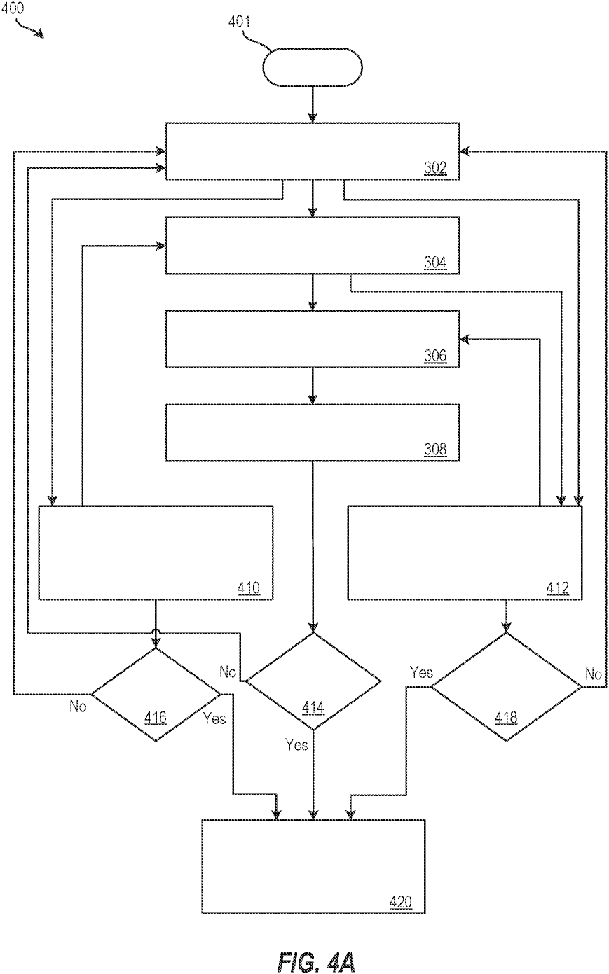

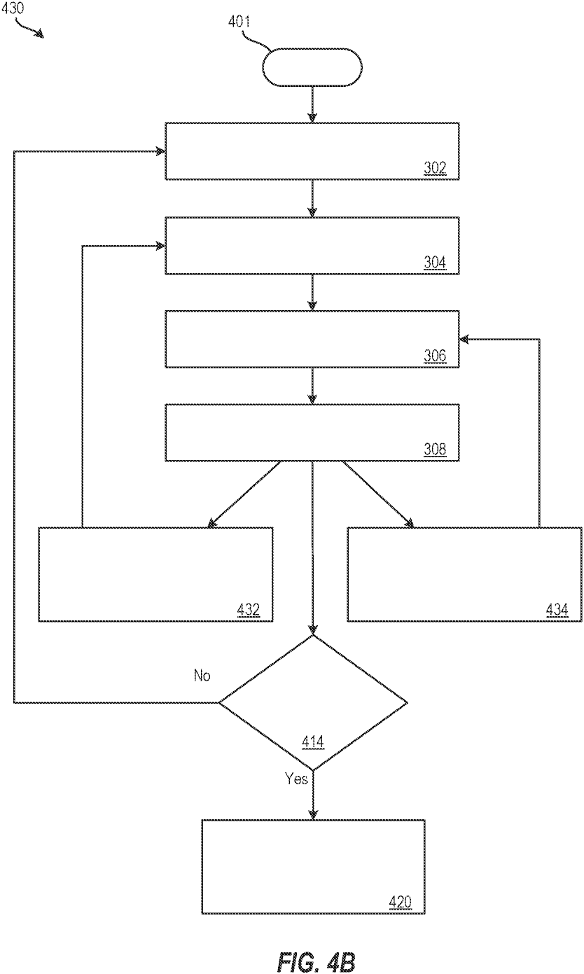

The thermal degradation engine 212 performs a thermal degradation analysis as described herein (see, e.g., FIG. 4A, FIG. 4B). There are two dominant failure mechanisms linked to thermal stress of a power inverter, namely wire bond damage and degradation of the solder layers. Wire bond damage can include crack, lift-off, and/or the like, including combinations and/or multiples thereof. During operation, high currents flow through wire bonds, which causes self-heating, thermal expansion, deformation, and/or the like, and can lead to mechanical stress, which may lead to irreversible lift-off or crack damage. Degradation of the solder layers, sometimes referred to as delamination can also occur. The temperature variations observed by the thermal degradation engine 212 can lead to mechanical stress for solder joints because of different thermal expansion coefficients of the components of the inverter 113. This effect may lead to solder cracks and to delamination, which in turn lead to an increase of the thermal resistance of the inverter 113 and higher junction temperatures. Thermal resistance can also change with respect to aging, as shown by the table below:

| | Lifetime Level | Degradation-Aging Impact | |
|---|---|---|---|
| | | Normalized R_{thjc} | Normalized V_{DS} |
| 1 | 0%-20% | 1 | 1 |
| 2 | 20%-40% | 1.1 | 1 |
| 3 | 40%-60% | 1.2 | 1.01 |
| 4 | 60%-80% | 1.3 | 1.03 |
| 5 | 80%-100% | 1.4 | 1.1 |

The thermal degradation engine 212 performs a thermal degradation analysis based on inverter usage as well as performance. The engine 212 uses a rainflow counting technique to determine an inverter damage factor and calculates a thermal resistance based on a estimated junction temperature and power loss model to indicate performance degradation.

The inverter damage factor can be determined, for example, using the following equation:

$$\begin{matrix}D = \frac{{N}_{c y c l e} \left(\text{Δ} T < T 1\right)}{{N}_{r e f} \left(\text{Δ} T < T 1\right)} + \frac{{N}_{c y c l e} \left(T 1 < \text{Δ} T < T 2\right)}{{N}_{r e f} \left(T 1 < \text{Δ} T < T 2\right)} + … + \\ \frac{{N}_{c y c l e} \left(T n - 1 < Δ T < T n\right)}{{N}_{r e f} \left(T n - 1 < Δ T < T n\right)} \left({T}_{1} < {T}_{2} < ⋯ < {T}_{n}\right)\end{matrix}$$

where D is the inverter damage factor, N_{cycle} is a number of cycles, N_{ref} is a reference value corresponding to the N_{cycle}, Tₙ is a temperature for each cycle, and ΔT is a change in temperature. The reference value (N_{ref}) corresponding to the N_{cycle} can be determined using a power cycling curve that expresses estimated temperature for the power inverter (based on model type, for example) depending on the number of cycles.

The inverter thermal resistance can be determined, for example, using the following equation:

$${R}_{t h} = \frac{{T}_{j u n c}}{{P}_{l o s s}} = \frac{f \left({T}_{N T C} , {T}_{c o o l}\right)}{{P}_{l o s s}}$$

where Rₜₕ is the thermal resistance, Tj_{unc} is the temperature of the junction of the power inverter, Pₗₒₛₛ is the power loss, T_{NTC} is the thermistor temperature, and T_{cool} is the temperature of the coolant. Based on the damage factor of the inverter, the junction temperature and/or the power loss can be adjusted to fit actual performance of the inverter according to one or more embodiments.

The electrical degradation engine 210 passes information relating to a determined electrical degradation (see, e.g., FIG. 4A) to an inverter loss engine 214. Similarly, the thermal degradation engine 212 passes information relating to a determined thermal degradation (see, e.g., FIG. 4A, FIG. 4B) to the temperature estimation engine 216. The inverter loss engine 214 receives the voltage (V_{ce} and/or V_{ds}), which could be measured or estimated. The controller 119 also receives vehicle operating conditions, from which the data 224 used to estimate inverter power loss is obtained. The data 224 can include one or more of the following: the power factor angle (Φ), the modulation index (MI), the switching frequency (f_{sw}), the measured three-phase current (I_{abc}), and the fundamental frequency (f_{fund}). The inverter loss engine 214 uses the data 224 to estimate power loss, which is used to estimate the junction temperature of IGBT/MOSFET (T_{IGBT}) and diode (T_{Diode}) by the temperature estimation engine 216. These temperatures are used for rainflow counting as described herein. Rainflow counting will then provide estimated aging of the inverter 113. This aging (or damage accumulation) is then considered to re-adjust the thermal and electrical parameters used to estimate power loss by the inverter loss engine 214 and junction temperature by the temperature estimation engine 216. This readjustment improves the robustness of the power loss and junction temperature estimation.

The controller 119 can also perform an aging calculation, which may be determined from the IGBT junction temperature (T_{IGBT}) and/or the diode temperature (T_{Diode}). The aging calculation can be, for example, a number of cycles counted using rainflow counting as described herein.

Rainflow counting is a technique used in fatigue analysis to determine a number of fatigue cycles based on historical data. Cycle counting in fatigue analysis techniques, such as the American Society for Testing and Materials (ASTM) Standard Practices for Cycle Counting in Fatigue Analysis can be applied and modified to obtain Tⱼ and ΔTⱼ fitting inverter applications. Data identifiers (DIDs) are created for recording Tⱼ, ΔTⱼ, and an accumulated damaging factor during a drive cycle. The following table depicts an example of rainflow counting. Particularly, this table shows a rainflow modified script with peak-valley data from the modified script.

| | | | | | | |
|---|---|---|---|---|---|---|
| dT/Tj | 65-75 | 75-100 | 100-125 | 125-150 | 150-175 | Sum |
| 0-10 | 4 | 0 | 0 | 0 | 0 | 0 |
| 10-20 | 0 | 4 | 0 | 0 | 0 | 4 |
| 20-30 | 0 | 4 | 0 | 0 | 0 | 4 |
| 30-40 | 0 | 0 | 4 | 0 | 0 | 4 |
| 40-50 | 0 | 0 | 4 | 0 | 0 | 4 |
| 50-60 | 0 | 0 | 0 | 3 | 0 | 3 |
| 60-70 | 0 | 0 | 0 | 1 | 0 | 1 |
| 70-80 | 0 | 0 | 0 | 0 | 0 | 0 |
| 80-90 | 0 | 0 | 0 | 0 | 0 | 0 |
| 90-100 | 0 | 0 | 0 | 0 | 4 | 4 |
| 100-110 | 0 | 0 | 0 | 0 | 0 | 0 |
| 110-120 | 0 | 0 | 0 | 0 | 0 | 0 |
| 120-130 | 0 | 0 | 0 | 0 | 0 | 0 |
| 130-140 | 0 | 0 | 0 | 0 | 0 | 0 |
| 140-150 | 0 | 0 | 0 | 0 | 0 | 0 |

In this example, the first column (dT/Tj) represents the change in junction temperature ΔTⱼ. Each of the second through fifth columns represent actual junction temperatures with the values providing the count for each occurrence of an actual temperature in the range defined by the change in junction temperature ΔTⱼ.

With continued reference to FIG. 2, information and/or data can be transmitted between the vehicle 100 and a remote system or device. For example, the controller 119 can be communicatively coupled to the remote processing system 250, which can be an edge processing node as part of an edge processing environment, a cloud processing node as part of a cloud processing environment, or the like. The controller 119 can also be communicatively coupled to one or more other vehicles (e.g., other vehicle(s) 254). In some examples, the controller 119 is communicatively coupled to the remote processing system 250 and/or the other vehicle(s) 254 directly (e.g., using vehicle-to-vehicle (V2V) communication), while in other examples, the controller 119 is communicatively coupled to the remote processing system 250 and/or the other vehicle(s) 254 indirectly, such as by a network 252. For example, the controller 119 can include or otherwise be associated with a network adapter (not shown) (see, e.g., the network adapter 526 of FIG. 5). The network adapter enables the controller 119 to transmit data to and/or receive data from other sources, such as other processing systems, data repositories, and the like including the remote processing system 250 and the other vehicle(s) 254. As an example, the controller 119 can transmit data to and/or receive data from the remote processing system 250 directly and/or via the network 252.

The network 252 represents any one or a combination of different types of suitable communications networks such as, for example, cable networks, public networks (e.g., the Internet), private networks, wireless networks, cellular networks, or any other suitable private and/or public networks. Further, the network 252 can have any suitable communication range associated therewith and may include, for example, global networks (e.g., the Internet), metropolitan area networks (MANs), wide area networks (WANs), local area networks (LANs), or personal area networks (PANs). In addition, the network 252 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof. According to one or more embodiments described herein, the remote processing system 250, the other vehicle(s) 254, and/or the controller 119 communicate via V2V, a vehicle-to-infrastructure (V2I), vehicle-to-pedestrian (V2P), and/or vehicle-to-grid (V2G) communication.

As an example, the vehicle 100, using the controller 119, can transmit information about the inverter 113, such as electrical degradation analysis results and/or thermal degradation analysis results to the remote processing system 250 for visualization and evaluation. For example, data about inverters from multiple vehicles can be aggregated and evaluated together to determine trends about particular inverters over time. This can be used to improve the design of future inverters, and to cause preventive maintenance to be performed before errors occur, etc. As an example, one or more of the thresholds described herein (e.g., the voltage threshold, the first and/or second thermal thresholds, etc.) can be adjusted based on the aggregated data. For example, if a particular trend is observed across power inverters for many vehicles, one or more thresholds can be adjusted (up and/or down) to account for such trends.

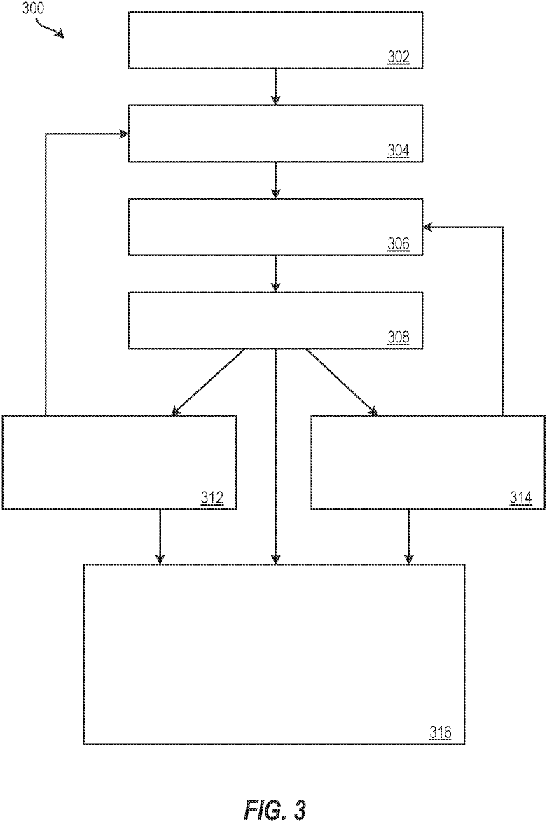

FIG. 3 depicts a flow diagram of a method 300 for analyzing power inventers for vehicles according to one or more embodiments described herein. The method 300 can be performed by any suitable system or device such as the controller 119 of FIGS. 1 and 2, the processing system 500 of FIG. 5, or any other suitable processing system and/or processing device (e.g., a processor). The method 300 is now described with reference to the elements of FIGS. 1 and/or 2 but is not so limited.

At block 302, the controller determines a vehicle operating condition. Examples of a vehicle operation condition include motor torque, motor speed, battery voltage, and/or the like, including combinations and/or multiples thereof. At block 304, the controller 119 estimates inverter power loss. At block 306, the controller 119 estimates the inverter junction temperature. At block 308, the controller 119 calculates the inverter damage factor.

At block 312, the controller 119, using the electrical degradation engine 210, performs an electrical degradation analysis for a power inverter (e.g., the inverter 113) of a vehicle (e.g., the vehicle 100). An example of an electrical degradation analysis is shown in FIG. 4A, as further described herein.

At block 314, the controller 119, using the thermal degradation engine 212, performs a thermal degradation analysis for the power inverter (e.g., the inverter 113) of the vehicle (e.g., the vehicle 100). An example of a thermal degradation analysis is shown in FIG. 4A and FIG. 4B, as further described herein.

At block 316, responsive to at least one of a result of the electrical degradation analysis being indicative of an electrical issue with the power inverter or a result of the thermal degradation analysis being indicative of a thermal issue with the power inverter, the controller 119 (and/or another suitable device) implements a corrective action for the power inverter. Examples of corrective actions include causing the vehicle 100 to navigate to a specific location (e.g., to a safe location, a service location, etc.) to avoid a failure in an undesirable location, issuing an alert to an operation of the vehicle 100 and/or to a service technician remote from the vehicle 100, causing the inverter 113 to be replaced and/or repaired, and/or the like, including combinations and/or multiples thereof.

As shown, the power loss and junction temperature estimation (and eventually, damage factor and prognostic decisions) accuracy is improved by feeding back inverter degradation information to the estimations (i.e., block 312 feeds back to block 304 and block 314 feeds back to block 306).

Additional processes also may be included, and it should be understood that the process depicted in FIG. 3 represents an illustration, and that other processes may be added or existing processes may be removed, modified, or rearranged without departing from the scope of the present disclosure.

FIG. 4A depicts a flow diagram of a method 400 for performing an electrical degradation analysis and a thermal degradation analysis for power inventers for vehicles according to one or more embodiments described herein. The method 400 can be performed by any suitable system or device such as the controller 119 of FIGS. 1 and 2, the processing system 500 of FIG. 5, or any other suitable processing system and/or processing device (e.g., a processor). The method 400 is now described with reference to the elements of FIGS. 1, 2, and/or 3 but is not so limited. The method 400 starts at block 401.

At block 302, the controller 119 determines a vehicle operation condition. At block 304, the controller 119 estimates the inverter power loss. At block 306, the controller 119 estimates the inverter junction temperature. At block 308, the controller 119 calculates the inverter damage factor.

At block 410, the controller 119 measures a collector-to-emitter voltage (V_{ce}) for the power inverter 113 under a specific temperature and current condition. At decision block 416, the controller 119 compares the voltage (V_{ce}) to a voltage threshold (i.e., a first threshold or “Th1”). According to one or more embodiments described herein, the voltage threshold is determined based at least in part on the measured collector-to-emitter voltage (V_{ce}) or a drain-to-source voltage (V_{ds}) value at a start of life and is updated over time (e.g., over the air in the controller 119). In one or more embodiments, this can include comparing a voltage difference (ΔV_{ce} or ΔV_{ds}) between the measured collector-to-emitter voltage (V_{ce}) and an expected collector-to-emitter voltage (V_{ce}) (e.g., a normal case) to the voltage threshold (i.e., a first threshold or “Th1”). For example, the voltage difference may be the expected collector-to-emitter voltage (V_{ce}) minus the measured collector-to-emitter voltage (V_{ce}). At decision block 416, the controller 119 determines whether the voltage threshold (i.e., the first threshold or “Th1”) is satisfied. For example, the voltage and/or the voltage difference may be considered to satisfy the voltage threshold when the voltage difference is greater than (or greater than or equal to) the voltage threshold. As another example, the voltage and/or the voltage difference may be considered to satisfy the voltage threshold when the voltage difference is less than (or less than or equal to) the voltage threshold. If at decision block 416, the controller 119 determines that the voltage threshold is satisfied, the method 400 proceeds to block 420, where it is determined that a degradation of the power inverter has occurred. If at decision block 416, the controller 119 determines that the voltage threshold is not satisfied, the method 400 proceeds back to block 302, and the degradation analysis restarts.

At block 412, the controller 119 calculates an inverter thermal impedance based on thermistor data. At decision block 418, the controller 119 determines whether the inverter thermal impedance satisfies a second thermal threshold (i.e., a third threshold or “Th3”). For example, the inverter thermal impedance may be considered to satisfy the second thermal threshold when the inverter thermal impedance is greater than (or greater than or equal to) the second thermal threshold. As another example, the inverter thermal impedance may be considered to satisfy the second thermal threshold when the inverter thermal impedance is less than (or less than or equal to) the second thermal threshold. If, at decision block 418, it is determined that the inverter thermal impedance does not satisfy the second thermal threshold, the method 400 returns to block 302 and repeats. If however, at decision block 418, it is determined that the second thermal threshold is satisfied, the method 400 continues to block 420, which indicates that a degradation of the power inverter has occurred.

At decision block 414, the controller 119 compares the damage factor (from block 308) to a first thermal threshold (i.e., a second threshold or “Th2”). That is, at decision block 414, the controller 119 determines whether the damage factor satisfies the first thermal threshold (i.e., a second threshold or “Th2”). For example, the damage factor may be considered to satisfy the first thermal threshold when the damage factor is greater than (or greater than or equal to) the first thermal threshold. As another example, the damage factor may be considered to satisfy the first thermal threshold when the damage factor is less than (or less than or equal to) the first thermal threshold. If, at decision block 414, it is determined that the damage factor does not satisfy the first thermal threshold, the method 400 returns to block 302 and repeats. If however, at decision block 414, it is determined that the first thermal threshold is satisfied, the method 400 continues to block 420, which indicates that a degradation of the power inverter has occurred.

Together, the blocks 302, 304, 410, 416, and 420 represent the electrical degradation analysis; the blocks 302, 304, 306, 412, 418, and 420 together represent a first thermal degradation analysis; and the blocks 302, 304, 306, 308, 414, and 420 together represent a second thermal degradation analysis. The electrical degradation analysis, the first thermal degradation analysis, and the second thermal degradation analyses can be performed independently, sequentially, concurrently, simultaneously, and/or the like, including combinations and/or multiples thereof.

Additional processes also may be included, and it should be understood that the process depicted in FIG. 4A represents an illustration, and that other processes may be added or existing processes may be removed, modified, or rearranged without departing from the scope of the present disclosure.

FIG. 4B depicts a flow diagram of a method 430 for performing an electrical degradation analysis and a thermal degradation analysis for power inventers for vehicles according to one or more embodiments described herein. The method 430 can be performed by any suitable system or device such as the controller 119 of FIGS. 1 and 2, the processing system 500 of FIG. 5, or any other suitable processing system and/or processing device (e.g., a processor). The method 430 is now described with reference to the elements of FIGS. 1, 2, and/or 3 but is not so limited. The method 430 starts at block 401.

At block 302, the controller 119 determines a vehicle operation condition. At block 304, the controller 119 estimates the inverter power loss. At block 306, the controller 119 estimates the inverter junction temperature. At block 308, the controller 119 calculates the inverter damage factor.

At block 432, the controller 119 estimates the collector-to-emitter voltage (V_{ce}) for the power inverter 113 under a specific temperature and current condition. At block 434, the controller 119 estimates the thermal resistance (Rₜₕ) for the power inverter 113 as described herein. After each of the blocks 432, 434 are complete, the method returns to blocks 304, 306 respectively. The results of the estimates at blocks 432, 434 can be used to calculate the inverter damage factor at block 308 indirectly and/or directly.

At decision block 414, the controller 119 compares the damage factor (from block 308) to the first thermal threshold (i.e., the second threshold or “Th2”). That is, at decision block 414, the controller 119 determines whether the damage factor satisfies the first thermal threshold (i.e., the second threshold or “Th2”). For example, the damage factor may be considered to satisfy the first thermal threshold when the damage factor is greater than (or greater than or equal to) the first thermal threshold. As another example, the damage factor may be considered to satisfy the first thermal threshold when the damage factor is less than (or less than or equal to) the first thermal threshold. If, at decision block 414, it is determined that the damage factor does not satisfy the first thermal threshold, the method 430 returns to block 302 and repeats. If however, at decision block 414, it is determined that the second thermal threshold is satisfied, the method 400 continues to block 420, which indicates that a degradation of the power inverter has occurred.

Additional processes also may be included, and it should be understood that the process depicted in FIG. 4B represents an illustration, and that other processes may be added or existing processes may be removed, modified, or rearranged without departing from the scope of the present disclosure.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node of a cloud computing environment. Cloud computing can supplement, support, or replace some or all of the functionality of the elements of the processing system 110, the remote processing system 150, and or the processing system 500.

In examples, processing system 500 has one or more central processing units (“processors” or “processing resources”) 521a, 521b, 521c, etc. (collectively or generically referred to as processor(s) 521 and/or as processing device(s)). In aspects of the present disclosure, each processor 521 can include a reduced instruction set computer (RISC) microprocessor. Processors 521 are coupled to system memory (e.g., random access memory (RAM) 524) and various other components via a system bus 533. Read only memory (ROM) 522 is coupled to system bus 533 and may include a basic input/output system (BIOS), which controls certain basic functions of processing system 500.

Further depicted are an input/output (I/O) adapter 527 and a network adapter 526 coupled to system bus 533. I/O adapter 527 may be a small computer system interface (SCSI) adapter that communicates with a hard disk 523 and/or a storage device 525 or any other similar component. I/O adapter 527, hard disk 523, and storage device 525 are collectively referred to herein as mass storage 534. Operating system 540 for execution on processing system 500 may be stored in mass storage 534. The network adapter 526 interconnects system bus 533 with an outside network 536 enabling processing system 500 to communicate with other such systems.

A display (e.g., a display monitor) 535 is connected to system bus 533 by display adapter 532, which may include a graphics adapter to improve the performance of graphics intensive applications and a video controller. In one aspect of the present disclosure, adapters 526, 527, and/or 532 may be connected to one or more I/O busses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 (or other suitable input and/or output device, such as a touch screen of an infotainment system of a vehicle or a microphone) may be interconnected to system bus 533 via user interface adapter 528, which may include, for example, a Super I/O chip integrating multiple device adapters into a single integrated circuit.

In some aspects of the present disclosure, processing system 500 includes a graphics processing unit 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing, and has a highly parallel structure that makes it more effective than general-purpose CPUs for algorithms where processing of large blocks of data is done in parallel.

Thus, as configured herein, processing system 500 includes processing capability in the form of processors 521, storage capability including system memory (e.g., RAM 524), and mass storage 534, input means such as keyboard 529 and mouse 530, and output capability including speaker 531 and display 535. In some aspects of the present disclosure, a portion of system memory (e.g., RAM 524) and mass storage 534 collectively store the operating system 540 to coordinate the functions of the various components shown in processing system 500.

As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The descriptions of the various examples of the present disclosure have been presented for purposes of illustration but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method comprising:
performing an electrical degradation analysis for a power inverter;
performing a thermal degradation analysis on the power inverter; and
responsive to at least one of a result of the electrical degradation analysis being indicative of an electrical issue of the power inverter or a result of the thermal degradation analysis being indicative of a thermal issue of the power inverter, implementing a corrective action for the power inverter.

2. The method of claim 1, wherein the electrical degradation analysis comprises:
measuring a measured collector-to-emitter voltage (V_{ce}) for the power inverter;
calculating a voltage difference between the measured collector-to-emitter voltage (V_{ce}) and an expected collector-to-emitter voltage (V_{ce}); and
determining whether the voltage difference satisfies a voltage threshold.

3. The method of claim 2, wherein the electrical degradation analysis further comprises, responsive to determining that the voltage difference satisfies the voltage threshold, determining that an electrical degradation of the power inverter has occurred.

4. The method of claim 2, wherein the electrical degradation analysis further comprises, responsive to determining that the voltage difference failing to satisfy the voltage threshold, restarting the electrical degradation analysis.

5. The method of claim 1, wherein the thermal degradation analysis comprises:
calculating an inverter damage factor; and
determining whether the inverter damage factor satisfies a first thermal threshold.

6. The method of claim 5, wherein the thermal degradation analysis further comprises:
calculating a thermal resistance; and
determining whether the thermal resistance satisfies a second thermal threshold.

7. The method of claim 6, wherein the thermal degradation analysis further comprises, responsive to determining that the inverter damage factor satisfies the first thermal threshold and responsive to determining that the thermal resistance satisfies the second thermal threshold, determining that an thermal degradation of the power inverter has occurred.

8. The method of claim 6, wherein the thermal degradation analysis further comprises, responsive to determining that the inverter damage factor fails to satisfy the first thermal threshold or responsive to determining that the thermal resistance fails to satisfy the second thermal threshold, restarting the thermal degradation analysis.

9. The method of claim 5, wherein the inverter damage factor is calculated using a rainflow counting technique.

10. The method of claim 1, further comprising, prior to performing an electrical degradation analysis and prior to performing a thermal degradation analysis:
estimating an inverter power loss;
estimating an inverter junction temperature;
calculating an inverter damage factor; and
feeding back inverter degradation information to the estimations.

11. A system comprising:
a memory comprising computer readable instructions; and
a processing device for executing the computer readable instructions, the computer readable instructions controlling the processing device to perform operations comprising:
performing an electrical degradation analysis for a power inverter;
performing a thermal degradation analysis on the power inverter; and
responsive to at least one of a result of the electrical degradation analysis being indicative of an electrical issue of the power inverter or a result of the thermal degradation analysis being indicative of a thermal issue of the power inverter, implementing a corrective action for the power inverter.

12. The system of claim 11, wherein the electrical degradation analysis comprises:
measuring a measured collector-to-emitter voltage (V_{ce}) for the power inverter;
calculating a voltage difference between the measured collector-to-emitter voltage (V_{ce}) and an expected collector-to-emitter voltage (V_{ce}); and
determining whether the voltage difference satisfies a voltage threshold.

13. The system of claim 12, wherein the electrical degradation analysis further comprises, responsive to determining that the voltage difference satisfies the voltage threshold, determining that an electrical degradation of the power inverter has occurred.

14. The system of claim 12, wherein the electrical degradation analysis further comprises, responsive to determining that the voltage difference failing to satisfy the voltage threshold, restarting the electrical degradation analysis.

15. The system of claim 11, wherein the thermal degradation analysis comprises:
calculating an inverter damage factor; and
determining whether the inverter damage factor satisfies a first thermal threshold.

16. The system of claim 15, wherein the thermal degradation analysis further comprises:
calculating a thermal resistance; and
determining whether the thermal resistance satisfies a second thermal threshold.

17. The system of claim 16, wherein the thermal degradation analysis further comprises, responsive to determining that the inverter damage factor satisfies the first thermal threshold and responsive to determining that the thermal resistance satisfies the second thermal threshold, determining that an thermal degradation of the power inverter has occurred.

18. The system of claim 16, wherein the thermal degradation analysis further comprises, responsive to determining that the inverter damage factor fails to satisfy the first thermal threshold or responsive to determining that the thermal resistance fails to satisfy the second thermal threshold, restarting the thermal degradation analysis.

19. The system of claim 12, wherein the voltage threshold is determined based at least in part on the measured collector-to-emitter voltage (V_{ce}) or a drain-to-source voltage (V_{ds}) value at a start of life and is updated over time.

20. The system of claim 11, wherein a difference between the V_{ce} of two or more switches of the power inverter indicates a start of an ageing related issue.
